(19) United States
(12) Patent Application Publication
(10) Pub. No.: US 2015/0274988 A1
(43) Pub. Date: Oct. 1, 2015

(54) PAINTABLE PHOTOWETTING COATINGS

(71) Applicant: EMPIRE TECHNOLOGY DEVELOPMENT, LLC, Wilmington, DE (US)

(72) Inventor: Vincenzo Casasanta III, Woodinville, WA (US)

(21) Appl. No.: 14/440,879

(22) PCT Filed: Oct. 24, 2013
(86) PCT No.: PCT/US13/66708

§ 371 Date: May 6, 2015

Related U.S. Application Data
(60) Provisional application No. 61/723,290, filed on Nov. 6, 2012.

(51) Int. Cl. C09D 5/24; C08K 3/08; C08K 3/22; C08K 9/04; B08B 17/06; C09D 163/00

(52) U.S. Cl. CPC C09D 5/24; B08B 17/06; C09D 163/00; C08K 3/22; C08K 9/04; C08K 3/08; C08K 2003/2241; C08K 2003/085

(57) ABSTRACT

Technologies are generally described for photo-wettable paint coatings. In some examples, a coating may include a charge photo-ejector, a charge transporter; and/or a charge storage material. The charge photo-ejector may absorb light and eject a charge. The charge may be received by the charge transporter and transported to the charge storage material, which may store charge at an air-paint interface. Alternating exposure to light and dark conditions, such as daytime and nighttime, may cycle surface energy states of the photo-wettable paint coating. The photo-wettable paint coating may cycle between a charged, wettable, relatively lower surface energy state when lighted and a relatively hydrophobic, higher surface energy state when in a charge-dissipated and/or unlighted state. Cycling between different states may promote self-cleaning of the photo-wettable paint coatings of contaminants, further in combination with water provided by rain, dew, washing, spraying, or the like.

### BACKGROUND

Unless otherwise indicated herein, the materials described in this section are not prior art to the claims in this application and are not admitted to be prior art by inclusion in this section.

Self-cleaning coatings, such as paints, are of current interest. Many paint finishes display a hydrophobic surface with high surface tension that may cause water to bead up and nm off the coating. Much current literature is focused on the pursuit of materials with increased surface tension such as super-hydrophobic material surfaces. Coatings have also been produced with low surface tension, for example, mediated by the many hydrophilic particulate additives included in various paints. However, high surface tension coatings and low surface tension coatings may not be self-cleaning under all conditions. Some conditions that may tend to clean relatively high surface tension coatings may tend to dirty relatively low surface tension coatings, and vice versa. The present disclosure appreciates that preparing self-cleaning coatings such as paints may be a complex undertaking.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes technologies relating to photo-wettable painted coatings, including liquid paints, methods to form painted coatings using liquid paints, methods to manufacture liquid paints, and painted articles.

In various examples, liquid paints configured to form photo-wettable painted coatings are provided. The liquid paint may include at least one charge photo-ejector material, at least one charge transporter material, at least one charge storage material, and at least one carrier liquid. The carrier liquid may be configured to form the liquid paint including the charge photo-ejector material, the charge transporter material, and the charge storage material. The charge storage material may be characterized by a first surface energy differential with respect to the carrier liquid. The charge storage material may self-segregate at a first average depth from an air-liquid interface of the liquid paint to leave at least a portion of the charge storage material located at the air-liquid interface. The liquid paint may be configured to dry and/or cure to form a painted coating. The painted coating may have an air-coating interface that includes the at least a portion of the self-segregated charge storage material. In the painted coating, the charge photo-ejector material may be configured to absorb light and/or photo-eject a charge into the charge transporter material. Also in the painted coating, the charge transporter material may be configured to transport the charge from the charge photo-ejector material to the charge storage material. Further in the painted coating, the charge storage material may be configured to store at least a portion of the charge at the air-coating interface to provide the photo-wettable painted coating.

In other examples, methods to form photo-wettable painted coatings on surfaces are provided. Example methods may include painting a surface with a liquid paint. The liquid paint may include at least one carrier liquid, at least one charge photo-ejector material, at least one charge transporter material, and at least one charge storage material. The charge storage material may be characterized by a first surface energy differential with respect to the carrier liquid. The methods may also include allowing the charge storage material to self-segregate according to the first surface energy differential. The charge storage material may self-segregate at a first average depth from an air-liquid interface of the liquid paint to leave at least a portion of the charge storage material located at the air-liquid interface. The methods may further include forming a painted coating by removing at least a portion of the carrier liquid from the liquid paint at the surface. The painted coating may have an air-coating interface that may include the at least a portion of the self-segregated charge storage material. In the painted coating, the charge photo-ejector material may be configured to absorb light and/or photo-eject a charge into the charge transporter material. Also in the painted coating, the charge transporter material may be configured to transport the charge from the charge photo-ejector material to the charge storage material. Further in the painted coating, the charge storage material may be configured to store at least a portion of the charge at the air-coating interface to provide the photo-wettable painted coating.

In further examples, methods to manufacture liquid paints configured to form photo-wettable painted coatings are provided. Example methods to manufacture may include mixing at least one carrier liquid together with at least one charge photo-ejector material, at least one charge transporter material, and at least one charge storage material to form the liquid paint. The charge storage material may be characterized by a first surface energy differential with respect to the carrier liquid. The charge storage material may self-segregate at a first average depth from an air-liquid interface of the liquid paint to leave at least a portion of the charge storage material located at the air-liquid interface. The liquid paint may be configured to dry and/or cure to form a painted coating having an air-coating interface that may include the at least a portion of the self-segregated charge storage material. In the painted coating, the charge photo-ejector material may be configured to absorb light and/or photo-eject a charge into the charge transporter material. Also in the painted coating, the charge transporter material may be configured to transport the charge from the charge photo-ejector material to the charge storage material. Further in the painted coating, the charge storage material may be configured to store at least a portion of the charge at the air-coating interface to provide the photo-wettable painted coating.

In yet other examples, painted articles are provided. Example painted articles may include an article having a surface. The painted articles may also include a photo-wettable paint coating at the surface. The photo-wettable paint coating may include at least one charge photo-ejector material, at least one charge transporter material; and at least one charge storage material. The charge storage material may be located at a first average depth from an air-paint interface of the photo-wettable paint coating such that at least a portion of the charge storage material may be located at the air-paint interface. The charge photo-ejector material may be configured to absorb light and/or photo-eject a charge into the charge transporter material. The charge transporter material may be configured to transport the charge from the charge photo-ejector material to the charge storage material. The charge storage material may be configured to store at least a portion of the charge at the air-paint interface to provide the painted article including the photo-wettable painted coating.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1A is a conceptual drawing representative of various examples of liquid paints and photo-wettable paint coatings at surfaces;

FIG. 1B is a conceptual drawing representing cycling of surfaces of photo-wettable coatings between less wettable, hydrophobic, higher surface energy states and more wettable, hydrophilic, lower energy states;

FIG. 2 is a conceptual drawing representing various aspects of techniques of forming photo-wettable painted coatings on surfaces, including painting surfaces with liquid paints, allowing self-segregation, and drying and/or curing to form the photo-wettable painted coatings;

FIG. 3 is a conceptual drawing representing various example bi-layer and tri-layer particles including two or more of the charge photo-ejector material, the charge transporter material, and the charge storage material;

FIG. 4 is a conceptual drawing representing various example processes for coating oleophilic and/or fluorophilic surfaces on one or more of the charge photo-ejector material, the charge transporter material, and the charge storage material;

FIG. 5 is a block diagram representing various examples automated machines that may be used in the various techniques of manufacturing the liquid paint;

FIG. 6 is a flow diagram representing example blocks that may be used in various example techniques of manufacturing the liquid paint;

FIG. 7 is a block diagram representing various example computer program products that may be used to control the various automated machines of FIG. 5 or similar equipment in the various techniques of manufacturing the liquid paint; and

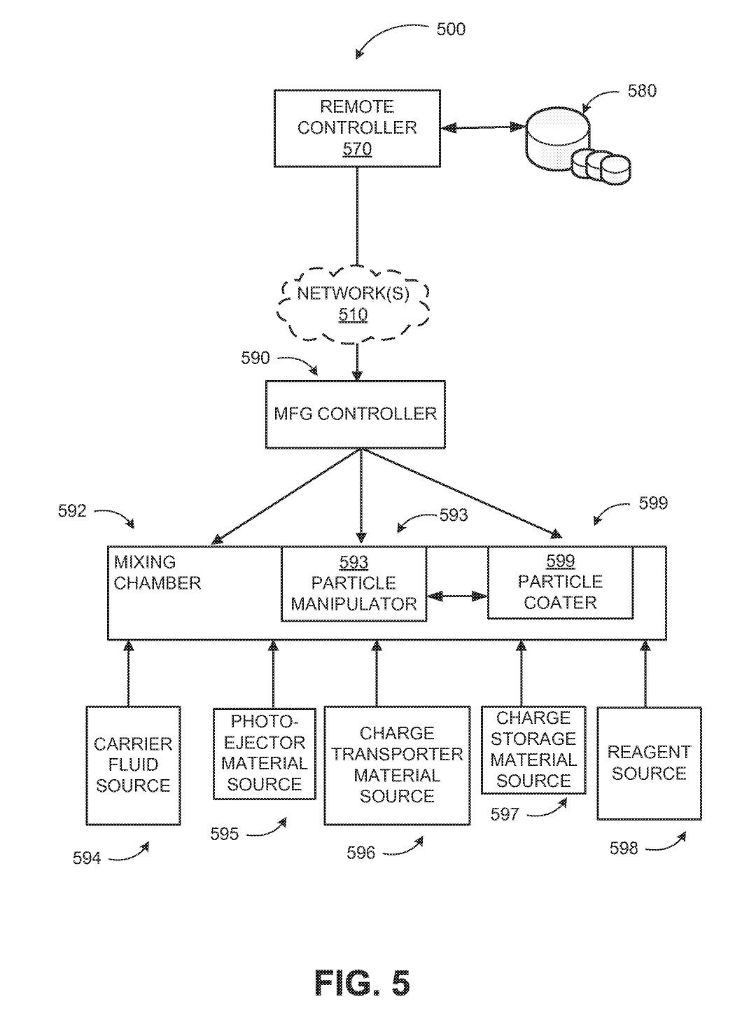

FIG. 8 is a block diagram representing various general purpose computing devices that may be used to control the various automated machines of FIG. 5 or similar equipment in the various techniques of manufacturing the liquid paint;
all arranged in accordance with at least some embodiments described herein.

### DETAILED DESCRIPTION

In the following detailed description, reference is made to the accompanying drawings, which form a part hereof. In the drawings, similar symbols may identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

The present disclosure generally describes technologies relating to photo-wettable painted coatings, including liquid paints, methods to form painted coatings using liquid paints, methods to manufacture liquid paints, and painted articles.

Briefly stated, technologies are generally described for photo-wettable paint coatings. In some examples, a coating may include a charge photo-ejector, a charge transporter; and/or a charge storage material. The charge photo-ejector may absorb light and eject a charge. The charge may be received by the charge transporter and transported to the charge storage material, which may store charge at an air-paint interface. Alternating exposure to light and dark conditions, such as daytime and nighttime, may cycle surface energy states of the photo-wettable paint coating. The photo-wettable paint coating may cycle between a charged, wettable, relatively lower surface energy state when lighted and a relatively hydrophobic, higher surface energy state when in a charge-dissipated and/or unlighted state. Cycling between different states may promote self-cleaning of the photo-wettable paint coatings of contaminants, further in combination with water provided by rain, dew, washing, spraying, or the like.

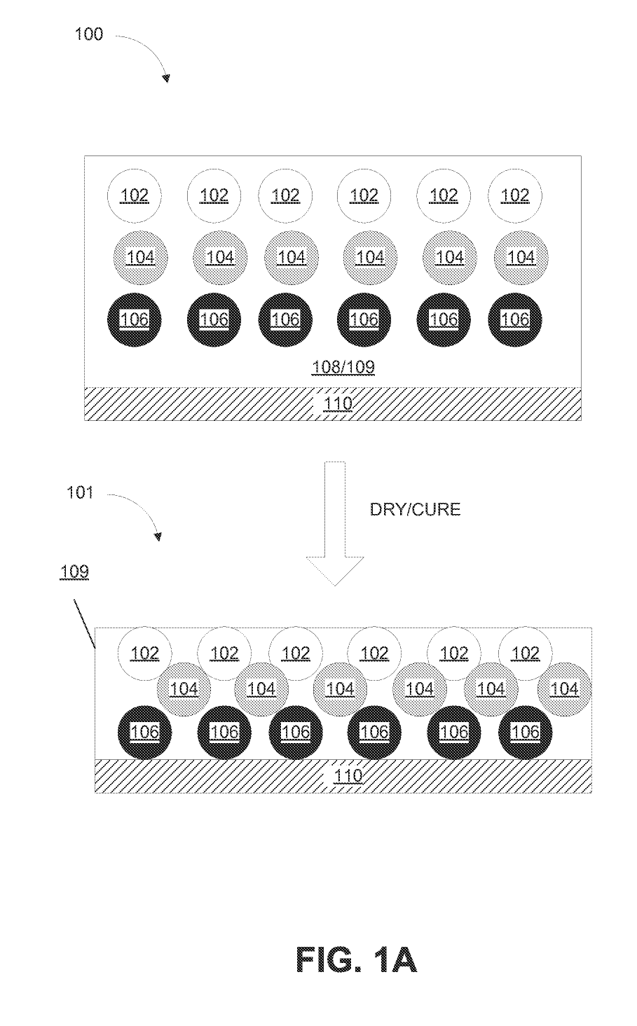

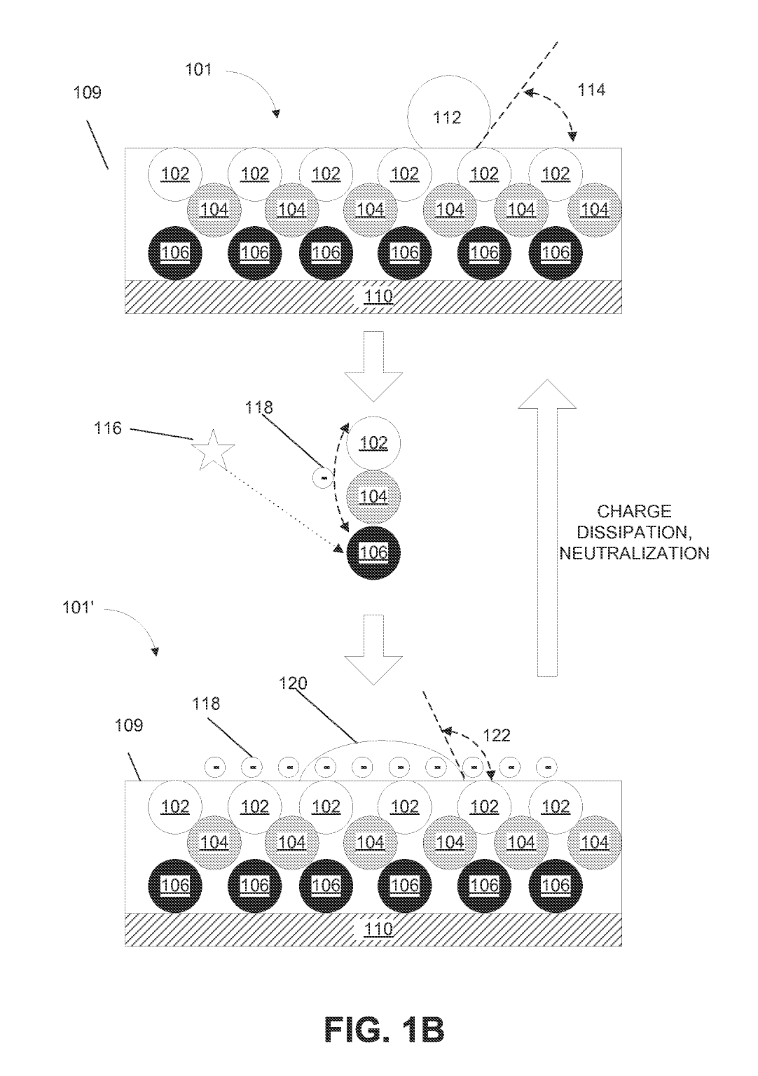

FIG. 1A is a conceptual drawing representative of various examples of liquid paints and photo-wettable paint coatings at surfaces, arranged in accordance with at least some embodiments described herein. FIG. 1 shows a liquid paint coating 100 at a surface 110. The liquid paint coating 100 may include a charge storage material 102, a charge transporter material 104, and a charge photo-ejector material 106, all in a carrier liquid 108. The carrier liquid 108 may include an optional binder 109. The liquid paint coating 100 may dry and/or cure to form a photo-wettable painted coating 101 that may include the charge photo-ejector material 106, the charge transporter material 104, and the charge storage material 102. The photo-wettable painted coating 101 may include the optional binder 109 in a cured state.

FIG. 1B is a conceptual drawing representing cycling of surfaces of photo-wettable coatings 101/101′ between less wettable, hydrophobic, higher surface energy states such as 101 and more wettable, hydrophilic, lower energy states such as 101′. Photo-wettable painted coatings 101/101′ are predicted to function as follows. The photo-wettable painted coating 101 may have a less wettable, hydrophobic, higher surface energy state as indicated by the contact angle 114 of the water droplet 112. Incident light, for example, from the sun 116 may be absorbed by the photo-ejector material 106. The photo-ejector material 106 may eject charge 118, depicted in FIG. 1A as a negative charge. The charge 118 may be positive or negative depending on the specific photo-ejector material employed. The ejected charge 118 may be received by the charge transporter material 104 and may be transported to the charge storage material 102. As the charge storage material 102 accumulates more charge, the surface of the photo-wettable coating becomes more wettable, hydrophilic, and lower energy in state 101′, as indicated by the contact angle 122 of the water droplet 120.

As depicted in FIG. 1B, the more wettable, hydrophilic, lower energy state 101′ may revert to the less wettable, hydrophobic, higher surface energy state 101 over time. Reversion of state 101′ towards state 101 may occur, for example, by charge dissipation, charge equalization, charge neutralization, or any other technique of reducing the charge 118 at the surface. For example, the photo-wettable coating in the more wettable, hydrophilic, lower energy state 101′ may be subject to a period of relative darkness, such as nighttime. Without a light source such as sun 116 to eject charge from the photo-ejector material 106, the charges 118 may tend to dissipate from the surface. In the presence of alternating periods of light and dark, such as daytime and nighttime, the photo-wettable coating may cycle between the less wettable, hydrophobic, higher surface energy state 101 and the more wettable, hydrophilic, lower energy state 101′.

As used herein, a charge storage material, for example, the charge storage material particles 102, may be any material configurable to store charge 118 at the surface of the painted coatings 101/101′. Suitable charge storage materials may include, for example, one or more of: silica; alumina; a fluoropolymer; a fluoroalkyl compound or group; a polyaliphatic, a polyester; or a combination, a compound, a composite, or a copolymer thereof. The charge storage material may be configured as a collection of particles having an average diameter in various examples of about 1 nm to about 100 μm, 10 nm to 100 μm, 100 nm to 100 μn, 1 μm to 100 μm, 10 μm to 100 μm, 10 nm to 10 μm, 100 nm to 10 μm, 1 μm to 10 μm, or any subrange thereof. Specific examples of average diameters are about 1 nm, about 100 nm, about 100 μm, and ranges between any two of these values (including endpoints). The charge storage material may also be configured as a coating or adsorbent on or adsorber of the charge transporter material.

As used herein, a charge transporter material, for example, the charge transporter material particles 104, may be any material configurable to transport a charge from the photo-ejector material to the charge storage material. In some examples, the charge transporter material may also be configurable to separate charges at the charge storage material from the photo-ejector material so as to slow recombination or back transport of charge from the charge storage material to the photo-ejector material. In several examples, the charge transporter material may also be configurable to provide a diode functionality that may favor charge transport in a direction from the photo-ejector material to the charge storage material. The ejected charge may be positive or negative depending on the photo-ejector material in question. Suitable charge transporter materials may include, for example, titanium dioxide; zinc oxide; zirconia; copper (I) oxide; or a combination or a composite thereof. The charge transporter material may be configured as a collection of particles having an average diameter in various examples of about 1 nm to about 100 μm, 10 nm to 100 μm, 100 nm to 100 μm, 1 μm to 100 μm, 10 μm to 100 μm, 10 nm to 10 μm, 100 nm to 10 μm, 1 μm to 10 μm, or any subrange thereof. Specific examples of average diameters are about 1 nm, about 100 nm, about 100 μm, and ranges between any two of these values (including endpoints). The charge transporter material may also be configured as a coating or adsorbent on or adsorber of the charge photo-ejector material and/or the charge storage material.

As used herein, a photo-ejector material, for example, the photo-ejector material particles 106, may be any material configurable to eject a charge upon absorption of one or more photons. The ejected charge may be positive or negative depending on the photo-ejector material in question. Example photo-ejector materials may include one or more of: a conjugated organic dye; a conjugated conductive or semi-conductive organic polymer; an inorganic quantum dot that includes a II-VI, III-V, or chalcogenide semiconductor; a rare earth organometallic dye; or a combination, a compound, a composite, or a copolymer thereof. In some examples, suitable photo-ejector materials may include photoejector materials employed in solar cells, particularly dye sensitized solar cells. Examples of such dyes may include, but are not limited to, compounds such as triscarboxy-rutheniumn terpyridine [Ru(4,4′,4″-(COOH)₃-terpy)(NCS)₃], 1-ethyl-3 methylimidazolium tetrocyanoborate [EMIB(CN)₄], or copper-diselenium [Cu(In,GA)Se₂]. The charge photo-ejector material may be configured as a collection of particles having an average diameter in various examples of about 1 nanometer (nm) to about 100 micrometers (μm), 10 nm to 100 μm, 100 nm to 100 μm, 1 μm to 100 μm, 10 μm to 100 μm, 10 nm to 10 μm, 100 nm to 10 μm, 1 μm to 10 μm, or any sub-range thereof. Specific examples of average diameters are about 1 nm, about 100 nm, about 100 μm, and ranges between any two of these values (including endpoints). The charge photo-ejector material may also be configured as a coating or adsorbent on or adsorber of the charge transporter material.

As used herein, the carrier liquid 108 may include any liquid configurable for use in a paint. In various examples, the carrier liquid may include one or more of water, a water-miscible organic solvent, or a curable binder. The carrier liquid may also include other components suitable for use in paints, such as pigments, dyes, surfactants, dispersants, flocculants, drying agents, wetting agents, solubility enhancers, antimicrobial agents, antifungal agents, pesticides, ultraviolet protecting agents, hardeners, plasticizers, or the like.

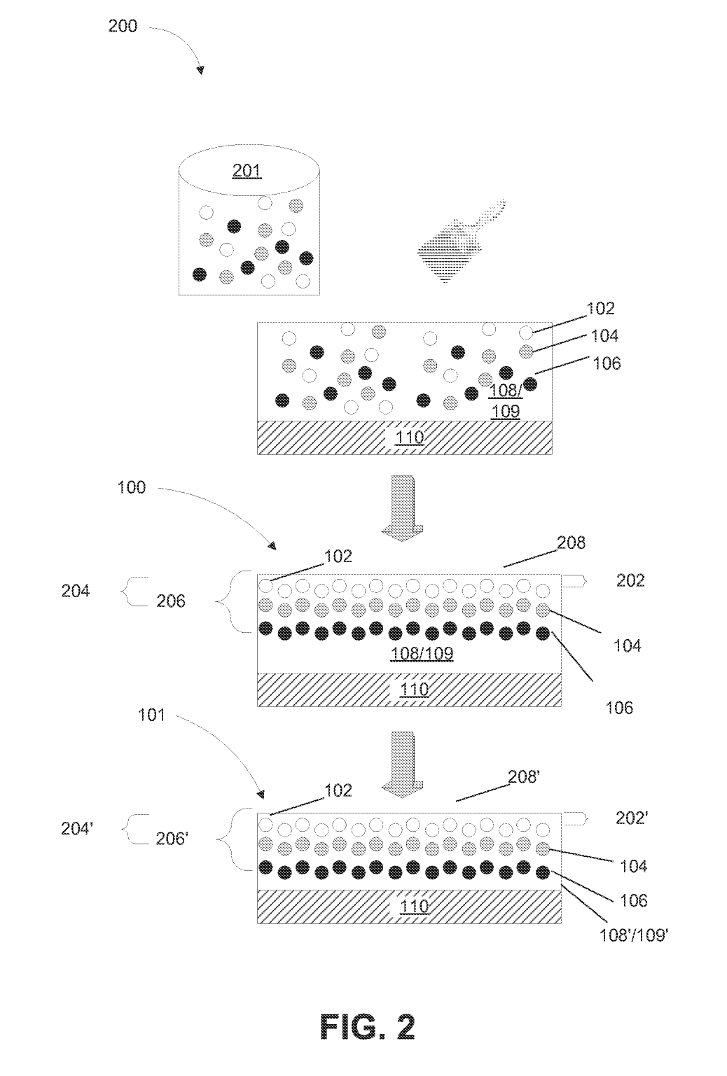

FIG. 2 is a conceptual drawing representing various aspects of techniques 200 of forming photo-wettable painted coatings on surfaces, including painting surfaces with liquid paints, allowing self-segregation, and drying and/or curing to form the photo-wettable painted coatings, all arranged in accordance with at least some embodiments described herein. In FIG. 2, a liquid paint reservoir 201 may include the carrier liquid 108, the optional binder 109, the photo-ejector 106, the charge transporter 104, and the charge storage material 102.

The liquid paint may be applied from reservoir 201 by any means suitable for painted coatings, such as by employing brushes, sponges, rollers, spray painting apparatus, dip coaters, spin coaters, or the like. Upon painting on a layer, the respective photo-ejector material 106, the charge transporter material 104, and the charge storage material 102 may be in a relatively mixed or disordered state in the carrier liquid 108. In some examples, the liquid paint may be mixed thoroughly before application, such as in reservoir 201.

The respective materials may be characterized by corresponding surface energy values with respect to the carrier liquid 108 that may cause the particles thereof to self-segregate in the liquid paint coating upon standing. For example, the charge storage material 102 may be characterized by a first surface energy differential versus the carrier liquid 108. According to the first surface energy differential, the charge storage material 102 may self-segregate in the carrier liquid 108 on standing. The charge storage material 102 may self-segregate in the carrier liquid 108 at a first average depth 202 from an air-liquid interface 208 of the liquid paint coating 100 to leave at least a portion of the charge storage material located at the air-liquid interface 208.

Also, for example, the charge transporter material 104 may be characterized by a second surface energy differential versus the carrier liquid 108. The second surface energy differential may be less than the first surface energy differential. According to the second surface energy differential, the charge transporter material 104 may self-segregate in the carrier liquid 108 at a second average depth 204 from the air-liquid interface 208 of the liquid paint coating 100. According to the lower value of the second surface energy differential and the first surface energy differential, the second average depth 204 may be greater than the first average depth 202.

Further, for example, the charge photo-ejector material 106 may be characterized by a third surface energy differential with respect to the carrier liquid 108 that is less than the first surface energy differential. The charge transporter material 106 may self-segregate at a third average depth 206 from the air-liquid interface 208 of the liquid paint coating 100. The third average depth 206 may be greater than the first average depth 202. In some examples, the third average depth 206 may be greater than the second average depth 204 and/or the first average depth 202.

In various examples, the carrier liquid 108 and/or the binder 109 in the liquid paint may be configured to dry or cure to form the photo-wettable painted coatings 101. The photo-wettable painted coatings 101 may include an air-coating interface 208′ corresponding to the air-liquid interface 208. The photo-wetted painted coatings 101 may include a first average depth 202′ of the charge storage particles 102, a second average depth 204′ of the charge transporter particles 104, and a third average depth 206′ of the photo-ejector particles 106. In some examples, the first, second, and third average depths 202′, 204′, and 206′ with respect to the air-coating interface 208′ may correspond to or may be different from the first, second, and third average depths 202, 204, and 206 with respect to the air-liquid interface 208. For example, the first, second, and third average depths 202′, 204′, and 206′ may be less than the first, second, and third average depths 202, 204, and 206 due to drying of the carrier liquid 108. In several examples, the first, second, and third average depths 202′, 204′, and 206′ may be greater than the first, second, and third average depths 202, 204, and 206, for example, due to curing of the binder 109.

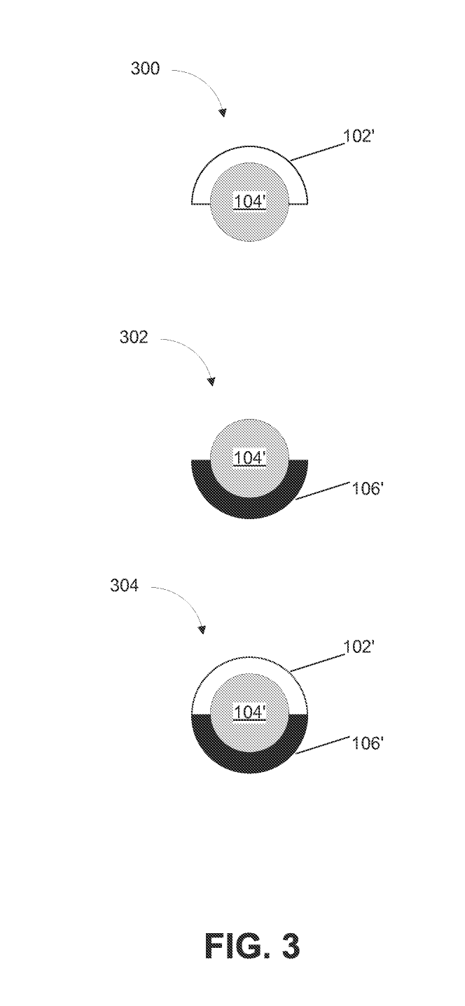

FIG. 3 is a conceptual drawing that represents various example bi-layer and tri-layer particles including two or more of the charge photo-ejector material 106, the charge transporter material 104, and the charge storage material 102, all arranged in accordance with at least some embodiments described herein. For example, bi-layer particle 300 represents a partial layer or coating of charge storage material 102 on charge transporter material 104. Bi-layer particle 302 represents a partial layer or coating of photo-ejector material 106 on charge transporter material 104. Tri-layer particle 304 represents a partial layer or coating of charge storage material 102 and a partial layer or coating of photo-ejector material 106 at least in part located on opposite sides of charge transporter material 104. Such hi-layer and tri-layer particles may be made by well-known techniques for forming partly coated microparticles. For example, particles of charge transporter material 104 may be partly embedded in a soft polymer matrix such as polydimethyl siloxane by roll printing. The exposed surfaces of the charge transporter material 104 may be coated by one or the other of the photo-ejector material 106 or the charge storage material 102 and released to form the bilayer particles 302 or 300, respectively. Alternatively, instead of releasing, the bi-layer particles 302 or 300 may be embedded in a second soft polymer matrix and removed from the first polymer matrix. The newly exposed surfaces of the charge transporter material 104 may then be coated with the other of the photo-ejector material 106 or the charge storage material 102 and released to form the tri-layer particles 304.

Such hi-layer 300,302 and/or tri-layer 304 particles may be configured to self-orient to place the corresponding materials in substantially the same relative order versus surfaces such as the air-liquid interface 208 or the air-coating interface 208′ as for the individual material particles shown in FIGS. 1A, 1B, and 2. In some examples, performance of the photo-wetting coatings may be improved versus the individual material particles shown in FIGS. 1A, 1B, and 2 according to the intimate contact of the layered materials in the bi-layer 300,302 and/or tri-layer 304 particles. In several examples, formation of the photo-wetting coatings may be improved where self-orientation of the bi-layer 300,302 and/or tri-layer 304 particles may be simpler or more effective compared to self-segregation of the individual material particles shown in FIGS. 1A, 1B, and 2.

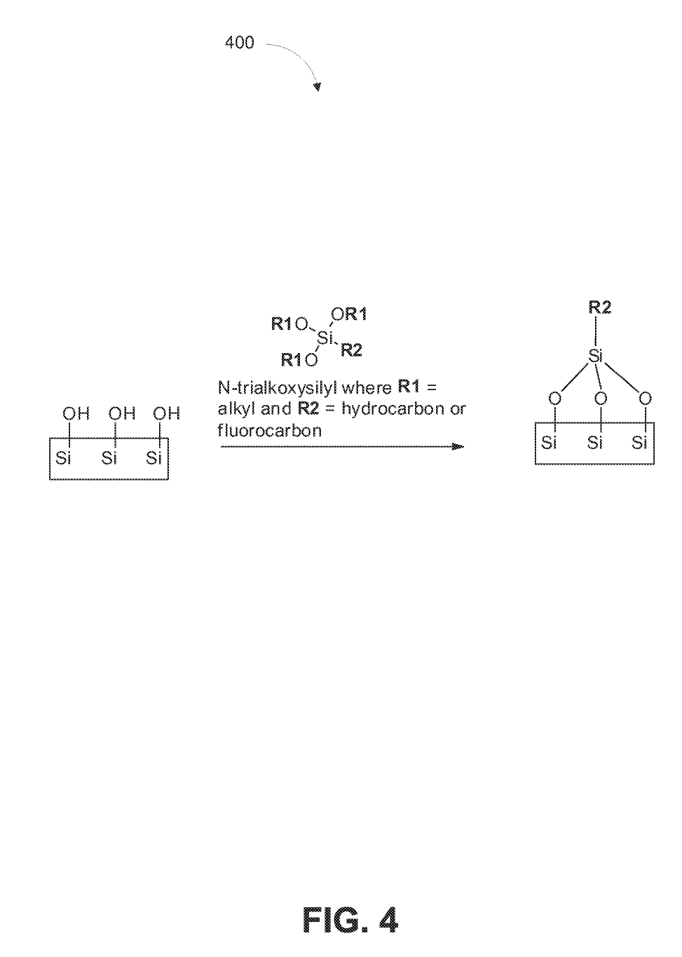

FIG. 4 is a conceptual drawing that represents various example processes for coating an oleophilic and/or fluorophilic surface on one or more of the charge photo-ejector material 102, the charge transporter material 104, and the charge storage material 106, all arranged in accordance with at least some embodiments described herein. In particular, FIG. 4 represents covalent attachment of an alkyl or fluoroalkyl chain, represented by R, through well-known silyl ester forming reactions on the surface of silica.

The oleophilic or fluorophilic surface may be applied to modify or provide a desired surface energy differential between any desired layer or particle described herein and the carrier liquid 108. For example, suitable charge storage materials 102 as described herein may include silica. Silica may be hydrophilic and may have relatively low surface energy. In many examples, it may be desirable to have a relatively high surface energy differential between the charge storage material 102 and the carrier liquid 108, which may not be achieved if the charge storage material is silica and the carrier liquid 108 includes water. An oleophilic or fluorophilic coating on the silica/charge storage material 102 may provide a greater surface energy differential versus water in the carrier liquid 108. In various examples, the oleophilic or fluorophilic coated silica may tend to self-orient or self-segregate towards the air-liquid interface in liquid paint coatings 100. The oleophilic or fluorophilic coatings may be applied by non-covalent coating, or covalent chemical reaction as depicted in FIG. 4. Advantageously, since charge storage materials may include fluoropolymers and fluoroalkyl groups as described herein, attachment of a fluoroallkyl silyl ester layer to a silica particle may provide an effective composite charge storage material 102.

Example embodiments may also include methods of manufacturing the liquid paint as described herein. These techniques may be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. The various human operators need not be collocated with each other, and instead each operated cal be located about one or more machines that perform a portion of the operations. In other examples, the human interaction may be automated such as by pre-selected criteria that may be machine automated.

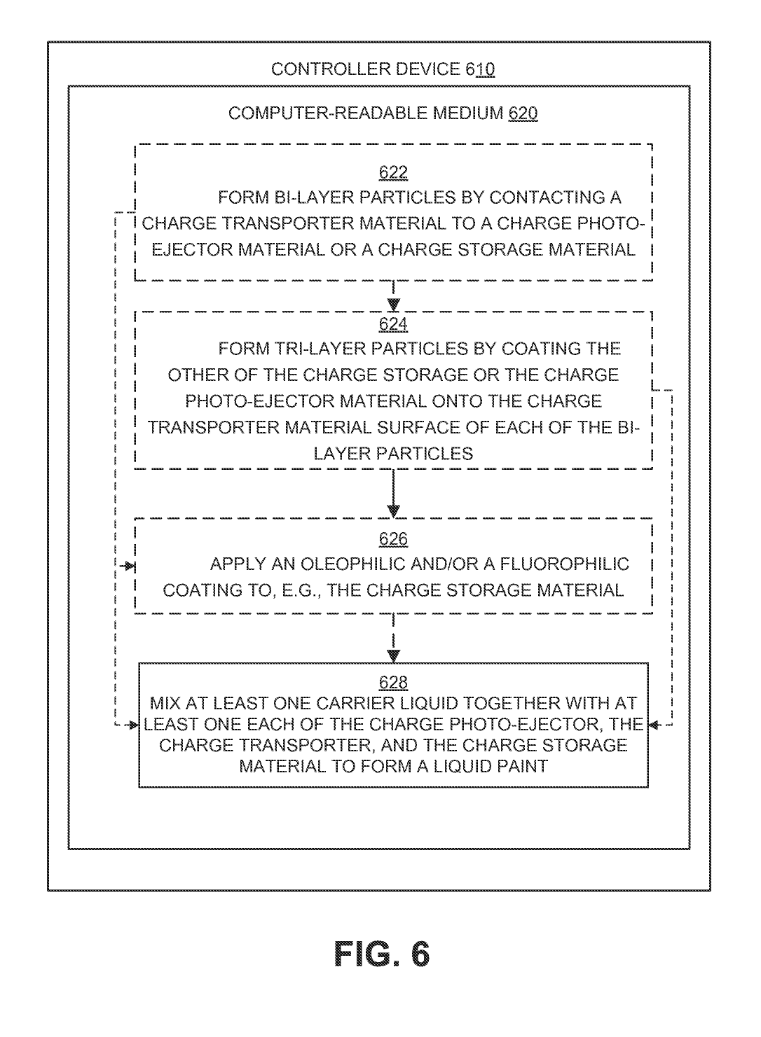

FIG. 5 is a block diagram that represents various example automated machines 500 that may be used in the various techniques to manufacture the liquid paint, all arranged in accordance with at least some embodiments described herein. As illustrated in FIG. 5, a manufacturing controller 590 may be coupled to the machines that may be employed to carry out the operations described in FIG. 6, for example: a mixing chamber 592; a particle manipulator 593; a carrier fluid source 594; a photo-ejector material source 595; a charge transporter material source 596; a charge storage material source 597; a reagent source 598; and a particle coating apparatus 599.

Manufacturing controller 590 may be operated by human control, by a remote controller 570 via network 510, or by machine executed instructions such as might be found in a computer program. Data associated with controlling the different processes of manufacturing the liquid paint may be stored at and/or received from data stores 580. Further, the individual elements of manufacturing system 500 may be implemented as any suitable device configured in any suitable fashion for carrying out the operations described herein. For example, particle manipulator 593 may be a colloid deposition apparatus which may be stationary or may include a sample stage with one or more moving functions, such as translation in zero, one, two, or three perpendicular axes, rotation in one, two, or three perpendicular axes, or combinations thereof. Such moving functions may be provided by motors, linear actuators, or piezoelectric actuators. Likewise, particle coater 599 may be configured for any approach for depositing a reagent such as an oleophilic or fluorophilic coating precursor from reagent source 598, such as by mixing, spraying, condensing, inkjet printing, or the like. Additionally or alternatively, particle manipulator and/or particle coater 599 may be employed in combination with the respective material sources 595, 596, and 597 to prepare the bi-layer or tri-layer particles by partly coating a collection of core particles of the charge transporter material with a layer of one or both of the photo-ejector material and/or the charge storage material. Similarly, the photo-ejector material source 595; the charge transporter material source 596; and the charge storage material source 597 may be configured to provide the respective materials as particles or as coatable compositions or reagents, depending on the desired particle to be formed, such as the bi-layer and tri-layer particles described herein. Further, the mixing chamber 592 and carrier fluid source 594 may be employed to contact particles of the respective materials with the liquid to form the liquid paint as described herein.

FIG. 6 is a flow diagram showing example blocks that may be used in various example techniques to manufacture the liquid paint, all arranged in accordance with at least some embodiments described herein. A process to manufacture liquid paint as described herein may include one or more operations, functions or actions as is illustrated by one or more of operations 622, 624, 626, and/or 628. An example technique to manufacture liquid paint as described herein may be operated by a controller device 610, which may be embodied as computing device 800 in FIG. 8 or a special purpose controller such as manufacturing controller 590 of FIG. 5, or similar devices configured to execute instructions stored in computer-readable medium 620 for controlling the performance of the technique. Example methods may include one or more operations to manufacture liquid paint. The computer-executable instructions may be executed by the controller device 610 in order to perform the operations of FIG. 6.

Some example processes may begin with operation 628, “MIX AT LEAST ONE CARRIER LIQUID TOGETHER WITH AT LEAST ONE EACH OF THE CHARGE PHOTO-EJECTOR, THE CHARGE TRANSPORTER, AND THE CHARGE STORAGE MATERIAL TO FORM A LIQUID PAINT.” Operation 628 may be performed, for example, by employing the mixing chamber 592 and carrier fluid source 594 to contact particles of the respective materials with the liquid to form the liquid paint as described herein. Operation 628 may be preceded by any of optional operations 622, 624, and/or 628, or any other technique operations described herein.

For example, operation 628 may be preceded by optional operation 626, “APPLY AN OLEOPHILIC AND/OR A FLUOROPHILIC COATING TO THE CHARGE STORAGE MATERIAL.” Optional operation 626 may include contacting a coating of the oleophilic or fluorophilic coating to the respective materials, for example, by providing the coating precursor from the reagent source 598 to the particle coater 599. Optional operation 626 may be applied to the charge storage material alone, or the charge storage material as included in the optional bi-layer or tri-layer particles, prepared in optional operations 622 and/or 624.

Optional operation 626 may be preceded by optional operation 622, “FORM BI-LAYER PARTICLES BY CONTACTING A CHARGE TRANSPORTER MATERIAL TO A CHARGE PHOTO-EJECTOR MATERIAL OR A CHARGE STORAGE MATERIAL.” Optional operation 622 may include, for example, providing the charge transporter, charge storage, or charge photo-ejector materials from the respective material sources 595, 596, or 597 to the particle manipulator. Optional operation 622 may include, for example, employing the particle manipulator 593 to partly embed charge transporter particles into a polymeric surface such that each of the particles includes an embedded and an exposed surface. Optional operation 622 may include, for example, employing the particle coater 599 to coat a layer of the charge storage material and/or the charge photo-ejector material on the charge transporter material to provide the bi-layer particles. Optional operation 622 may also include, for example, employing the particle manipulator 593 to release the bi-layer embedded particles from the polymeric surface to expose the charge transporter material surface of each of the bi-layer particles. Optional operation 622 may further include, for example, employing the particle manipulator 593 to embed the exposed surfaces of the bi-layer embedded particles into a second polymeric surface. Optional operation 622 may further include, for example, employing the particle manipulator 593 to release the charge transporter material surface of each of the bi-layer particles from the polymer to leave the bi-layer particles embedded in the second polymeric surface with the charge transporter material exposed.

In some examples, optional operation 622 may be followed by operation 628, described above. In several examples, optional operation 622 may be followed by optional operation 624 “FORM TRI-LAYER PARTICLES BY COATING THE OTHER OF THE CHARGE STORAGE OR THE CHARGE PHOTO-EJECTOR MATERIAL ONTO THE CHARGE TRANSPORTER MATERIAL SURFACE OF EACH OF THE BI-LAYER PARTICLES.” Optional operation 624 may include, for example, employing the particle coater 599 to coat a layer of the charge storage material or the charge photo-ejector material on the exposed charge transporter material of the bilayer particles to provide the tri-layer particles. Optional operation 624 may be followed by operation 628 or optional operation 626 as described above.

The operations included in the process of FIG. 6 described above are for illustration purposes. A process of manufacturing the liquid paint as described herein may be implemented by similar processes with fewer or additional operations. In some examples, the operations may be performed in a different order. In some other examples, various operations may be eliminated. In still other examples, various operations may be divided into additional operations, or combined together into fewer operations. Although illustrated as sequentially ordered operations, in some implementations the various operations may be performed in a different order, or in some cases various operations may be performed at substantially the same time. For example, any other similar process may be implemented with fewer, different, or additional operations so long as such similar processes manufacture the liquid paint described herein.

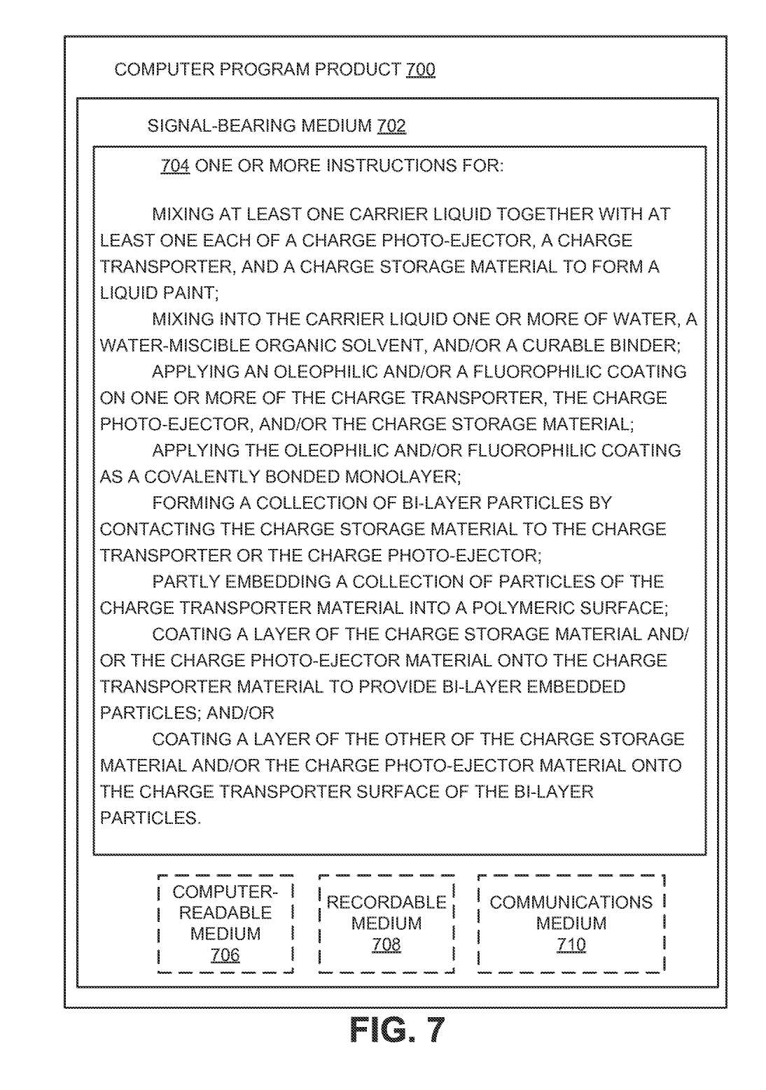

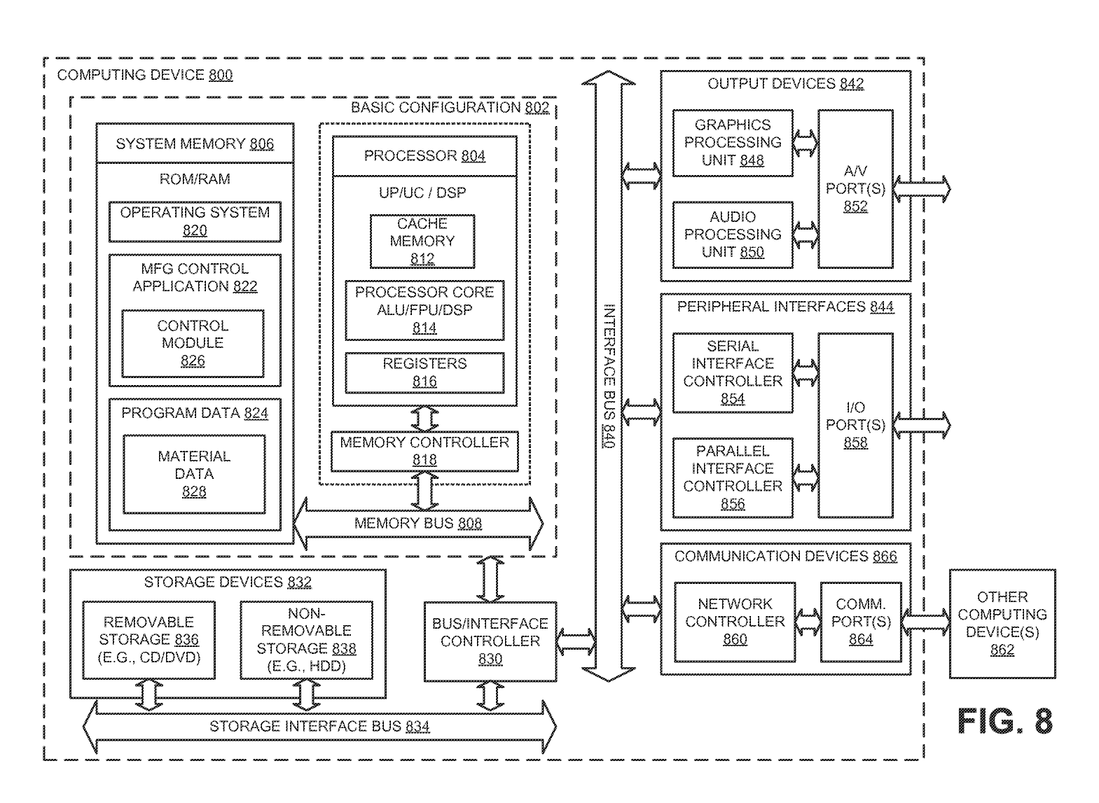

FIG. 7 is a block diagram that illustrates various example computer program products that may be used to control the various automated machines of FIG. 5 or similar equipment in the various techniques of manufacturing the liquid paint, all arranged in accordance with at least some embodiments described herein. In some examples, as shown in FIG. 7, computer program product 700 may include a signal bearing medium 702 that may also include machine readable instructions 704 that, when executed by, for example, a processor, may provide the functionality described above with respect to FIG. 6 through FIG. 8. For example, referring to manufacturing controller 590, one or more of the tasks shown in FIG. 7 may be undertaken in response to machine readable instructions 704 conveyed to the imaging controller 590 by signal bearing medium 702 to perform actions associated with manufacturing liquid paint as described herein. Some of those instructions may include, for example, one or more instructions for: “mixing at least one carrier liquid together with at least one each of a charge photo-ejector, a charge transporter, and a charge storage material to form a liquid paint;” “mixing into the carrier liquid one or more of water, a water-miscible organic solvent, and/or a curable binder;” “applying an oleophilic and/or a fluorophilic coating on one or more of the charge transporter, the charge photo-ejector, and/or the charge storage material;” “applying the oleophilic and/or fluorophilic coating as a covalently bonded monolayer;” “forming a collection of bi-layer particles by contacting the charge storage material to the charge transporter or the charge photo-ejector;” “partly embedding a collection of particles of the charge transporter material into a polymeric surface;” “coating a layer of the charge storage material and/or the charge photo-ejector material onto the charge transporter material to provide bi-layer embedded particles; and/or “coating a layer of the other of the charge storage material and/or the charge photo-ejector material onto the charge transporter surface of the bi-layer particles.”

In some implementations, signal bearing medium 702 depicted in FIG. 7 may encompass a computer-readable medium 706, such as, but not limited to, a hard disk drive, a Compact Disc (CD), a Digital Versatile Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (for example, a fiber optic cable, a waveguide, a wired communications link, a wireless communication link, etc.). For example, computer program product 700 may be conveyed to the processor 804 by an RF signal bearing medium 702, where the signal bearing medium 702 may be conveyed by a communications medium 710 (for example, a wireless communications medium conforming with the IEEE 802.11 standard). While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks may be performed by remote processing devices that may be linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

FIG. 8 is a block diagram that represents various general purpose computing devices that may be used to control the various automated machines of FIG. 5 or similar equipment in the various methods of manufacturing the liquid paint, all arranged in accordance with at least some embodiments described herein. In a basic configuration 802, referring to the components within the dashed line, computing device 800 may include one or more processors 804 and a system memory 806. A memory bus 808 may be used for communicating between processor 804 and system memory 806.

Depending on the desired configuration, processor 804 may be of any type including but not limited to a microprocessor (μP), a microcontroller (μC), a digital signal processor (DSP), or any combination thereof. Processor 804 may include one more levels of caching, such as a level cache memory 812, a processor core 814, and registers 816. Processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804.

Depending on the desired configuration, system memory 806 may be of any type including but not limited to volatile memory (such as RAM), non-volatile memory (such as ROM, flash memory, etc.) or any combination thereof. System memory 806 may include an operating system 820, one or more manufacturing control applications 822, and program data 824. Manufacturing control application 822 may include a control module 826 that may be arranged to control manufacturing system 500 of FIG. 5 and any other processes, methods and functions as discussed above. Program data 824 may include, among other data, material data 828 for controlling various aspects of the manufacturing system 500.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof. Examples of removable storage and non-removable storage devices may include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 806, removable storage devices 836 and non-removable storage devices 838 may be examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of computing device 800.

Computing device 800 may also include an interface bus 840 for facilitating communication from various interface devices (for example, output devices 842, peripheral interfaces 844, and communication devices 866 to basic configuration 802 via bus/interface controller 830. Output devices 842 may include a graphics processing unit 848 and an audio processing unit 850, which may be configured to communicate to various external devices such as a display or speakers via one or more A/V ports 852. Example peripheral interfaces 844 include a serial interface controller 854 or a parallel interface controller 856, which may be configured to communicate with external devices such as input devices (for example, keyboard, mouse, pen, voice input device, touch input device, etc.) or other peripheral devices (for example, printer, scanner, etc.) via one or more I/O ports 858. A communication device 866 may include a network controller 860, which may be arranged to facilitate communications with one or more other computing devices 862 over a network communication link via one or more communication ports 864.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 800 may be implemented as a portion of a physical server, virtual server, a computing cloud, or a hybrid device that include any of the above functions. Computing device 800 may also be implemented as a personal computer including both laptop computer and non-laptop computer configurations. Moreover computing device 800 may be implemented as a networked system or as part of a general purpose or specialized server.

Networks for a networked system including computing device 800 may comprise any topology of servers, clients, switches, routers, modems, Internet service providers, and any appropriate communication media (for example, wired or wireless communications). A system according to embodiments may have a static or dynamic network topology. The networks may include a secure network such as an enterprise network (for example, a LAN, WAN, or WLAN), an unsecure network such as a wireless open network (for example, IEEE 802.11 wireless networks), or a world-wide network such (for example, the Internet). The networks may also comprise a multitude of distinct networks that may be adapted to operate together. Such networks may be configured to provide communication between the nodes described herein. By way of example, and not limitation, these networks may include wireless media such as acoustic, RF, infrared and other wireless media. Furthermore, the networks may be portions of the same network or separate networks.

Throughout this specification, the term “platform” may be a combination of software and hardware components for providing a configuration environment, which may facilitate configuration of software/hardware products and services for a variety of purposes. Examples of platforms include, but are not limited to, a hosted service executed over a multitude of servers, an application executed on a single computing device, and comparable systems. The term “server” generally refers to a computing device executing one or more software programs in a networked environment. However, a server may also be implemented as a virtual server (software programs) executed on one or more computing devices viewed as a server on the network. More detail on these technologies and example operations is provided below.

In various examples, a liquid paint configured to form a photo-wettable painted coating is provided. The liquid paint may include at least one charge photo-ejector material, at least one charge transporter material, at least one charge storage material, and at least one carrier liquid. The carrier liquid may be configured to form the liquid paint including the charge photo-ejector material, the charge transporter material, and the charge storage material. The charge storage material may be characterized by a first surface energy differential with respect to the carrier liquid. The charge storage material may self-segregate at a first average depth from an air-liquid interface of the liquid paint to leave at least a portion of the charge storage material located at the air-liquid interface. The liquid paint may be configured to dry and/or cure to form a painted coating. The painted coating may have an air-coating interface that includes the at least a portion of the self-segregated charge storage material. In the painted coating, the charge photo-ejector material may be configured to absorb light and/or photo-eject a charge into the charge transporter material. Also in the painted coating, the charge transporter material may be configured to transport the charge from the charge photo-ejector material to the charge storage material. Further in the painted coating, the charge storage material may be configured to store at least a portion of the charge at the air-coating interface to provide the photo-wettable painted coating.

In some examples of the liquid paint, the charge photo-ejector material may include one or more of: a conjugated organic dye; a conjugated conductive or semi-conductive organic polymer; an inorganic quantum dot that may include a II-VI, III-V, or chalcogenide semiconductor; a rare earth organometallic dye; or a combination, a compound, a composite, and/or a copolymer thereof. The charge transporter material may include one or more of: titanium dioxide; zinc oxide; zirconia; copper (I) oxide; and/or a combination or a composite thereof. The charge storage material may include one or more of: silica; alumina; a fluoropolymer; a fluoroalkyl compound or group; a polyaliphatic, a polyester; or a combination, a compound, a composite, and/or a copolymer thereof. The carrier liquid may include one or more of water, a water-miscible organic solvent, and/or a curable binder.

In several examples of the liquid paint, one or more of the charge photo-ejector material, the charge transporter material, and/or the charge storage material may be configured as a collection of particles. The collection of particles may have an average diameter of about 1 nanometer to about 100 micrometers. The charge transporter material may be characterized by a second surface energy differential with respect to the carrier liquid. The second surface energy differential may be less than the first surface energy differential such that the charge transporter material may self-segregate at a second average depth from the air-liquid interface of the liquid paint. The second average depth may be greater than the first average depth. The charge photo-ejector material may be characterized by a third surface energy differential with respect to the carrier liquid. The third surface energy differential may be less than the first surface energy differential, such that the charge transporter material may self-segregate at a third average depth from the air-liquid interface of the liquid paint. The third average depth may be greater than the first average depth. The third surface energy differential may be less than the second surface energy differential. The third average depth may be greater than the second average depth.

In various examples, the liquid paint may include an oleophilic and/or fluorophilic surface on one or more of the charge photo-ejector material, the charge transporter material, and/or the charge storage material. The oleophilic and/or fluorophilic surface may be a covalently bonded monolayer. The oleophilic and/or fluorophilic surface may provide the charge storage material with the first surface energy differential with respect to the liquid carrier. The oleophilic and/or fluorophilic surface may provide the charge transporter with a second surface energy differential with respect to the liquid carrier that may be less than the first surface energy differential. The oleophilic and/or fluorophilic surface may provide the charge photo-ejector material with a third surface energy differential with respect to the liquid carrier that may be less than the first surface energy differential and/or the second surface energy differential.

In some examples, the liquid paint may include a collection of bi-layer particles that each may include a layer of the charge storage material in contact with a layer of the charge transporter material. The charge transporter material may be characterized by a second surface energy differential with respect to the carrier liquid. The collection of bi-layer particles may self-orient at least in part according to the first and/or second surface energy differentials. The collection of bi-layer particles may self-orient to direct the layer of the charge storage material on the collection of bi-layer particles towards the air-liquid interface. The collection of bi-layer particles may self-orient to direct the layer of the charge transporter material on the collection of bi-layer particles away from the air-liquid interface.

In several examples, the liquid paint may include a collection of bi-layer particles that each may include a layer of the charge transporter material in contact with a layer of the charge photo-ejector material. The charge transporter material may be characterized by a second surface energy differential with respect to the carrier liquid. The charge photo-ejector material may be characterized by a third surface energy differential with respect to the carrier liquid. The collection of bi-layer particles may self-orient at least in part according to the second and/or third surface energy differentials. The collection of bi-layer particles may self-orient to direct the layer of the charge transporter material on the collection of hi-layer particles towards the air-liquid interface. The collection of bi-layer particles may self-orient to direct the layer of the charge photo-ejector material on the collection of bi-layer particles away from the air-liquid interface. The collection of bi-layer particles may self-segregate at a second average depth from the air-liquid interface of the liquid paint that may be greater than the first average depth.

In many examples, the liquid paint may include a collection of tri-layer particles that each may include a layer of the charge transporter material sandwiched between a layer of the charge storage material and a layer of the charge photo-ejector material. The charge transporter material may be characterized by a second surface energy differential with respect to the carrier liquid. The charge photo-ejector material may be characterized by a third surface energy differential with respect to the carrier liquid that may be less than the first surface energy differential. The collection of tri-layer particles may self-orient at least in part according to the first and/or third surface energy differentials. The collection of tri-layer particles may self-orient to direct the layer of the charge storage material of the collection of tri-layer particles to the air-liquid interface. The collection of tri-layer particles may self-orient to direct the layer of the charge photo-ejector material of the collection of tri-layer particles away from the air-liquid interface.

In various examples, a method of forming a photo-wettable painted coating on a surface is provided. The method may include painting a surface with a liquid paint. The liquid paint may include at least one carrier liquid, at least one charge photo-ejector material, at least one charge transporter material, and at least one charge storage material. The charge storage material may be characterized by a first surface energy differential with respect to the carrier liquid. The method may also include allowing the charge storage material to self-segregate according to the first surface energy differential. The charge storage material may self-segregate at a first average depth from an air-liquid interface of the liquid paint to leave at least a portion of the charge storage material located at the air-liquid interface. The method may further include forming a painted coating by removing at least a portion of the carrier liquid from the liquid paint at the surface. The painted coating may have an air-coating interface that may include the at least a portion of the self-segregated charge storage material. In the painted coating, the charge photo-ejector material may be configured to absorb light and/or photo-eject a charge into the charge transporter material. Also in the painted coating, the charge transporter material may be configured to transport the charge from the charge photo-ejector material to the charge storage material. Further in the painted coating, the charge storage material may be configured to store at least a portion of the charge at the air-coating interface to provide the photo-wettable painted coating.

In some examples, the method may include allowing the charge transporter material to self-segregate at a second average depth from the air-liquid interface of the liquid paint that may be greater than the first average depth. The charge transporter material may be characterized by a second surface energy differential with respect to the carrier liquid that may be less than the first surface energy differential. The charge transporter material may self-segregate at the second average depth according to the second surface energy differential. The method may also include allowing the charge transporter material to self-segregate at a third average depth from the air-liquid interface of the liquid paint that may be greater than the first average depth. The charge photo-ejector material may be characterized by a third surface energy differential with respect to the carrier liquid that may be less than the first surface energy differential. The charge transporter material may self-segregate at the third average depth according to the third surface energy differential. The third surface energy differential may be less than the second surface energy differential. The third average depth may be greater than the second average depth.

In several examples, one or more of the charge photo-ejector material, the charge transporter material, and/or the charge storage material may include an oleophilic and/or fluorophilic surface. The oleophilic and/or fluorophilic surface may be a covalently bonded monolayer.

In various examples, the method may include providing the liquid paint with the charge storage material and the charge transporter material configured together as a collection of bi-layer particles. Each of the hi-layer particles may include a layer of the charge storage material in contact with a layer of the charge transporter material. The method may include allowing the collection of bi-layer particles to self-orient such that the layer of the charge storage material on the collection of bi-layer particles may self-orient towards the air-liquid interface and the layer of the charge transporter material on the collection of bi-layer particles may self-orient away from the air-liquid interface. The charge transporter material may be characterized by a second surface energy differential with respect to the carrier liquid. The collection of bi-layer particles may self-orient at least in part according to the first and/or second surface energy differentials.

In some examples, the method may include providing the liquid paint with the charge storage material and the charge photo-ejector material configured together as a collection of bi-layer particles. Each of the bi-layer particles may include a layer of the charge transporter material in contact with a layer of the charge photo-ejector material. The method may also include allowing the collection of bi-layer particles to self-orient such that the layer of the charge transporter material on the collection of bi-layer particles may self-orient towards the air-liquid interface and the layer of the charge photo-ejector material on the collection of bi-layer particles may self-orient away from the air-liquid interface. The method may also include allowing the collection of bi-layer particles to self-segregate at a second average depth from the air-liquid interface of the liquid paint that may be greater than the first average depth. The charge transporter material may be characterized by a second surface energy differential with respect to the carrier liquid. The charge photo-ejector material may be characterized by a third surface energy differential with respect to the carrier liquid. The collection of bi-layer particles may self-orient at least in part according to the second and/or third surface energy differentials.

In various examples, the method may further include providing the liquid paint with the charge transporter material, the charge storage material, and the charge photo-ejector material configured together as a collection of tri-layer particles. Each of the tri-layer particles may include a layer of the charge transporter material sandwiched between a layer of the charge storage material and a layer of the charge photo-ejector material. The method may also include allowing the collection of tri-layer particles to self-orient according to the first and/or third surface energy differentials such that the layer of the charge storage material on the collection of tri-layer particles may self-orient towards the air-liquid interface and/or the layer of the charge photo-ejector material on the collection of tri-layer particles may self-orient away from the air-liquid interface. The charge transporter material may be characterized by a second surface energy differential with respect to the carrier liquid. The charge photo-ejector material may be characterized by a third surface energy differential with respect to the carrier liquid that may be less than the first surface energy differential. The collection of tri-layer particles may self-orient at least in part according to the first and/or third surface energy differentials.

In some examples, the charge photo-ejector material may include one or more of: a conjugated organic dye; a conjugated conductive or semi-conductive organic polymer; an inorganic quantum dot that may include a II-VI, III-V, or chalcogenide semiconductor; a rare earth organometallic dye; or a combination, compound, composite, and/or copolymer thereof. The charge transporter material may include one or more of: titanium dioxide; zinc oxide; zirconia; copper (I) oxide; and/or a combination or a composite thereof. The charge storage material may include one or more of: silica; alumina; a fluoropolymer; a fluoroalkyl compound or group; a polyaliphatic, a polyester; and/or a combination, a compound, a composite, or a copolymer thereof.

In several examples, the liquid paint may include at least one curable binder. The method may further include forming the painted coating by curing at least a portion of the curable binder.

In various examples, a method of manufacturing a liquid paint configured to form a photo-wettable painted coating is provided. The method of manufacturing may include mixing at least one carrier liquid together with at least one charge photo-ejector material, at least one charge transporter material, and at least one charge storage material to form the liquid paint. The charge storage material may be characterized by a first surface energy differential with respect to the carrier liquid. The charge storage material may self-segregate at a first average depth from an air-liquid interface of the liquid paint to leave at least a portion of the charge storage material located at the air-liquid interface. The liquid paint may be configured to dry and/or cure to form a painted coating having an air-coating interface that may include the at least a portion of the self-segregated charge storage material. In the painted coating, the charge photo-ejector material may be configured to absorb light and/or photo-eject a charge into the charge transporter material. Also in the painted coating, the charge transporter material may be configured to transport the charge from the charge photo-ejector material to the charge storage material. Further in the painted coating, the charge storage material may be configured to store at least a portion of the charge at the air-coating interface to provide the photo-wettable painted coating.

In various examples, the charge photo-ejector material may include one or more of: a conjugated organic dye; a conjugated conductive or semi-conductive organic polymer; an inorganic quantum dot that may include a II-VI, III-V, or chalcogenide semiconductor; a rare earth organometallic dye; and/or a combination, a compound, a composite, or a copolymer thereof. The charge transporter material may include: titanium dioxide; zinc oxide; zirconia; copper (I) oxide; and/or a combination or a composite thereof. The charge storage material may include: silica; alumina; a fluoropolymer: a fluoroalkyl compound or group; a polyaliphatic, a polyester; and/or a combination, a compound, a composite, or a copolymer thereof.

In various examples, the method of manufacturing may include mixing into the carrier liquid one or more of water, a water-miscible organic solvent, and/or a curable binder. The method of manufacturing may include applying an oleophilic and/or a fluorophilic coating on one or more of the charge storage material, the charge transporter material, and/or the charge photo-ejector material. The method of manufacturing may include applying the oleophilic and/or the fluorophilic coating on the charge storage material such that the charge storage material may be characterized by the first surface energy differential with respect to the carrier liquid. The method of manufacturing may include applying the oleophilic and/or the fluorophilic coating on the charge transporter material such that the charge transporter material may be characterized by a second surface energy differential with respect to the carrier liquid that may be less than the first surface energy differential. The charge transporter material may self-segregate at a second average depth from the air-liquid interface of the liquid paint that may be greater than the first average depth. The method of manufacturing may include applying the oleophilic and/or the fluorophilic coating on the charge photo-ejector material such that the charge photo-ejector material may be characterized by a third surface energy differential with respect to the carrier liquid that may be less than the first surface energy differential. The charge transporter material may self-segregate at a third average depth from the air-liquid interface of the liquid paint that may be greater than the first average depth. The third surface energy differential may be less than the second surface energy differential. The third average depth may be greater than the second average depth.

In some examples, the method of manufacturing may include applying the oleophilic and/or fluorophilic coating as a covalently bonded monolayer. The method of manufacturing may include forming a collection of bi-layer particles by contacting a layer of the charge storage material to a layer of the charge transporter material. The charge transporter material may be characterized by a second surface energy differential with respect to the carrier liquid such the collection of bi-layer particles may self-orient at least in part according to the first and/or second surface energy differentials. The collection of bi-layer particles may self-orient to direct the layer of the charge storage material on the collection of bi-layer particles towards the air-liquid interface. The collection of bi-layer particles may self-orient to direct the layer of the charge transporter material on the collection of bi-layer particles away from the air-liquid interface.

In several examples, the method of manufacturing may include forming a collection of bi-layer particles by contacting a layer of the charge transporter material to a layer of the charge photo-ejector material. The charge transporter material may be characterized by a second surface energy differential with respect to the carrier liquid. The charge photo-ejector material may be characterized by a third surface energy differential with respect to the carrier liquid. The collection of bi-layer particles may self-orient at least in part according to the second and/or third surface energy differentials to direct the layer of the charge transporter material on the collection of bi-layer particles towards the air-liquid interface and/or to direct the layer of the charge photo-ejector material on the collection of bi-layer particles away from the air-liquid interface. The collection of bi-layer particles may self-segregate at a second average depth from the air-liquid interface of the liquid paint that may be greater than the first average depth.

In various examples, the method of manufacturing may include forming a collection of tri-layer particles that each may include a layer of the charge transporter material sandwiched between a layer of the charge storage material and a layer of the charge photo-ejector material.

Forming the tri-layer particles may include partly embedding a collection of particles of the charge transporter material into a polymeric surface such that each of the particles of the charge transporter material may include an embedded surface and an exposed surface. Forming the tri-layer particles may also include coating a layer of the charge storage material and/or the charge photo-ejector material onto each exposed surface of the particles of the charge transporter material to provide a collection of bi-layer embedded particles each having a charge transporter material surface. Forming the tri-layer particles may further include releasing the bi-layer embedded particles from the polymeric surface to expose the charge transporter material surface of each of the bi-layer particles. Forming the tri-layer particles may also include coating a layer of the other of the charge storage material and/or the charge photo-ejector material onto the charge transporter material surface of each of the bi-layer particles to form the collection of tri-layer particles. The charge transporter material may be characterized by a second surface energy differential with respect to the carrier liquid. The charge photo-ejector material may be characterized by a third surface energy differential with respect to the carrier liquid that may be less than the first surface energy differential. The collection of tri-layer particles may self-orient at least in part according to the first and/or third surface energy differentials to direct the layer of the charge storage material on the collection of tri-layer particles to the air-liquid interface and/or to direct the layer of the charge photo-ejector material on the collection of tri-layer particles away from the air-liquid interface.

In various examples, a painted article is provided. The painted article may include an article having a surface. The painted article may also include a photo-wettable paint coating at the surface. The photo-wettable paint coating may include at least one charge photo-ejector material, at least one charge transporter material; and at least one charge storage material. The charge storage material may be located at a first average depth from an air-paint interface of the photo-wettable paint coating such that at least a portion of the charge storage material may be located at the air-paint interface. The charge photo-ejector material may be configured to absorb light and/or photo-eject a charge into the charge transporter material. The charge transporter material may be configured to transport the charge from the charge photo-ejector material to the charge storage material. The charge storage material may be configured to store at least a portion of the charge at the air-paint interface to provide the painted article including the photo-wettable painted coating.

In some examples of the painted article, the charge photo-ejector material may include one or more of: a conjugated organic dye; a conjugated conductive or semi-conductive organic polymer; an inorganic quantum dot that may include a II-VI, III-V, or chalcogenide semiconductor; a rare earth organometallic dye; and/or a combination, a compound, a composite, or a copolymer thereof. The charge transporter material may include one or more of: titanium dioxide; zinc oxide; zirconia; copper (I) oxide; and/or a combination or a composite thereof. The charge storage material may include one or more of: silica; alumina; a fluoropolymer; a fluoroalkyl compound or group; a polyaliphatic, a polyester; and/or a combination, a compound, a composite, or a copolymer thereof. The photo-wettable painted coating may include at least one cured binder. One or more of the charge photo-ejector material, the charge transporter material, and the charge storage material may be configured as a collection of particles having an average diameter of about 1 nanometer to about 100 micrometers. The charge transporter material may be located at a second average depth from the air-coating interface that may be greater than the first average depth. The charge photo-ejector material may be located at a third average depth from the air-coating interface that may be greater than the first average depth. The third average depth may be greater than the second average depth.

In several examples, the painted article may include an oleophilic and/or fluorophilic surface on one or more of the charge photo-ejector material, the charge transporter material, and the charge storage material. The oleophilic and/or fluorophilic surface may be a covalently bonded monolayer. The painted article may further include a collection of bi-layer particles that each may include a layer of the charge storage material in contact with a layer of the charge transporter material, wherein the collection of bi-layer particles may be characterized by a net orientation such that the layer of the charge storage material on the collection of bi-layer particles may be directed towards the air-coating interface to a greater extent compared to the layer of the charge transporter material on the collection of hi-layer particles.

In many examples, the painted article may include a collection of bi-layer particles that each may include a layer of the charge transporter material in contact with a layer of the charge photo-ejector material. The collection of bi-layer particles may be characterized by a net orientation such that the layer of the layer of the charge transporter material on the collection of bi-layer particles may be directed towards the air-coating interface to a greater extent compared to the layer of the charge photo-ejector material on the collection of bi-layer particles. The collection of bi-layer particles may be located at a second average depth from the air-coating interface that may be greater than the first average depth.

In various examples, the painted article may include a collection of tri-layer particles that each may include a layer of the charge transporter material sandwiched between a layer of the charge storage material and a layer of the charge photo-ejector material. The collection of tri-layer particles may be characterized by a net orientation such that the layer of the charge storage material on the collection of tri-layer particles may be directed towards the air-coating interface to a greater extent compared to the layer of the charge photo-ejector material on the collection of tri-layer particles.

The terms “a” and “an” as used herein mean “one or more” unless the singular is expressly specified. For example, reference to “a base” may include a mixture of two or more bases, as well as a single base.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to, plus or minus 10% of the particular term.

As used herein, the terms “optional” and “optionally” mean that the subsequently described circumstance may or may not occur, so that the description includes instances where the circumstance occurs and instances where it does not.

### EXAMPLES

### Example 1

### Formation of a Three-Particle Liquid Paint

### A liquid water base may

be combined with 2% by weight of a water soluble epoxy binder. Equal volumes of three particle distributions may be obtained, each having average particle diameters of about 10 micrometers. The particle distributions may include: copper-diselenium [Cu(In,GA)Se₂] as a photo-ejector material; titanium dioxide as a charge transporter material, precoated with a light hydrophobic layer; and fluoroalkyl-treated silica as a charge storage material. The titanium dioxide particles may be precoated with a light layer of paraffin by mixing into a 0.01% solution of paraffin in pentane, about 0.01% paraffin by weight versus the titanium dioxide. The particles and solution may be mixed and the pentane evaporated to leave the titanium dioxide particle distribution with a light hydrophobic coating of paraffin. The three particle distributions may be each added at a volume fraction versus the liquid water base of about 1% each by volume. A white latex base and desired pigment may be added. The mixture may be stirred thoroughly to form a liquid paint ready for application.

### Example 2

### Formation of a Tri-Layer Particle Liquid Paint

### Titanium dioxide-silica

particles having average particle diameters of about 10 micrometers may be obtained (JGC Catalysts and Chemicals, Ltd, Kawasaki City, Japan). The particles may be dried in an oven for 2 hours at 100° C., cooled, and suspended in an equal weight of dry tetrahydrofuran. Based on the silica surface area of the titanium dioxide-silica particles, slightly submolar amount of 1H,1H,2H,2H-perfluorooctyl triethoxysilane (Sigma Aldrich, St. Louis, Mo.) may be added and the mixture may be stirred for 4 hours to form a suspension of fluoroalkyl-functionalized titanium dioxide-silica particles. An equal mass of triscarboxy-ruthenium terpyridine [Ru(4,4′,4″-(COOH)₃-terpy)(NCS)₃] may be dissolved in a minimum amount of dry tetrahydrofuran and may be added to the suspension of fluoroalkyl-functionalized titanium dioxide-silica particles. The mixture may be stirred for 1 hour to allow the ruthenium complex to adsorb to the titanium dioxide. The ruthenium complex may adsorb preferentially to the titanium dioxide because the silica portion of the particles may be coated with the fluoroalkyl groups. The solvent may be then removed under reduced pressure to leave a collection of the tri-layer particles. The tri-layer particles may include a layer of the ruthenium dye as a photoejector material adsorbed on titanium dioxide as a charge transport material, capped by the fluoroalkyl-substituted silica as a charge storage layer. The collection of tri-layer particles may be added to a liquid water base that includes 2% of a water soluble epoxy binder. The collection of tri-layer particles may be added at a volume fraction versus the liquid water base of about 2% by volume. A white latex base and desired pigment may be added. The mixture may be stirred thoroughly to form a second liquid paint ready for application.

### Example 3

### Formation of a Photo-Wettable Painted Article Using the Three-Particle Liquid Paint

A coupon of exterior grade plywood may be obtained, painted with a primer base and allowed to dry. The three particle liquid paint of Example 1 may be mixed thoroughly and a single coat may be painted on the primer base on the plywood coupon. Upon painting, the three types of particles in the liquid paint may self-segregate. The fluorinated silica may rise to the air-liquid interface of the paint. The titanium dioxide precoated with a light hydrophobic layer may rise, settling below the fluorinated silica layer. The copper-diselenium [Cu(In,GA)Se₂] particles may settle below the titanium dioxide layer. The liquid paint may be allowed to dry/cure to form a photo-wettable painted coating on top of the primer-coated plywood coupon.

### Example 4

### Formation of a Photo-Wettable Painted Article Using the Tri-Layer Particle Liquid Paint

A coupon of exterior grade plywood may be obtained, painted with a primer base and allowed to dry. The tri-layer particle liquid paint of Example 2 may be mixed thoroughly and a single coat may be painted on the primer base on the plywood coupon. Upon painting, the tri-layer particles may self-orient to place the charge storage fluoroalkyl substituted silica layer at the air-liquid surface of the liquid paint. The photo-ejector ruthenium dye layer may point into the paint, away from the air-liquid surface. The charge transporting titanium dioxide layer may be sandwiched between the fluorinated silica layer and the adsorbed ruthenium dye layer. The liquid paint may be allowed to dry/cure to form a photo-wettable painted coating on top of the primer-coated plywood coupon.

### Example 5

### The Photo-Wettable Painted Article May Display Photo-Wetting Behavior

The painted plywood coupon of Example 3 or Example 4 may be placed in low-light, static discharging conditions and allowed to equilibrate. Next, a goniometer may be employed to measure the contact angle of water at the painted surface. The contact angle may be measured at a relatively hydrophobic angle of less than 90 degrees. Next, the painted plywood coupon may be exposed to sunlight for 1 hour. The contact angle of the water may be monitored by the goniometer as a function of time. The contact angle of the water may increase over time with the sunlight illumination until a relatively hydrophobic angle of greater than about 130 degrees may be reached. The painted coupon may then be protected from sunlight. The contact angle of the water may continue to be monitored by the goniometer as a function of time. The goniometer may show that the contact angle of the water decreases over time and may return to the original relatively hydrophobic angle of less than 90 degrees.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical manufacturing system may be implemented utilizing any suitable commercially available components, such as those sometimes found in data computing/communication and/or network computing/communication systems. The herein described subject matter sometimes illustrates different components contained within, or coupled together with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and allowing the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

The various aspects and embodiments disclosed herein are for purposes of illustration and are not intended to be limiting, with the true scope and spirit being indicated by the following claims.

1. A liquid paint configured to form a photo-wettable painted coating, the liquid paint comprising:
a charge photo-ejector material;
a charge transporter material;
a charge storage material; and
a carrier liquid configured to form the liquid paint including the charge photo-ejector material, the charge transporter material, and the charge storage material, wherein:
the charge storage material is characterized by a first surface energy differential with respect to the carrier liquid such that the charge storage material self-segregates at a first average depth from an air-liquid interface of the liquid paint to leave at least a portion of the charge storage material located at the air-liquid interface;
the liquid paint is configured to one or more of: dry and cure to form a painted coating having an air-coating interface that includes the at least a portion of the self-segregated charge storage material; and
in the painted coating, the charge photo-ejector material is configured to absorb light and photo-eject a charge into the charge transporter material, the charge transporter material is configured to transport the charge from the charge photo-ejector material to the charge storage material, and the charge storage material is configured to store at least a portion of the charge at the air-coating interface to provide the photo-wettable painted coating.

2. The liquid paint of claim 1, wherein the charge photo-ejector material includes one or more of: a conjugated organic dye, a conjugated conductive or semi-conductive organic polymer, an inorganic quantum dot that includes a II-VI, III-V, or chalcogenide semiconductor, a rare earth organometallic dye, and a combination, a compound, a composite, or a copolymer thereof.

3.-5. (canceled)

6. The liquid paint of claim 1, wherein one or more of the charge photo-ejector material, the charge transporter material, and the charge storage material is configured as a collection of particles having an average diameter of about 1 nanometer to about 100 micrometers.

7. The liquid paint of claim 6, wherein the charge transporter material is characterized by a second surface energy differential with respect to the carrier liquid that is less than the first surface energy differential, such that the charge transporter material self-segregates at a second average depth from the air-liquid interface of the liquid paint that is greater than the first average depth.

8. The liquid paint of claim 7, wherein the charge photo-ejector material is characterized by a third surface energy differential with respect to the carrier liquid that is less than the first surface energy differential, such that the charge transporter material self-segregates at a third average depth from the air-liquid interface of the liquid paint that is greater than the first average depth.

9. (canceled)

10. The liquid paint of claim 6, further comprising an oleophilic or fluorophilic surface on one or more of the charge photo-ejector material, the charge transporter material, and the charge storage material.

11. The liquid paint of claim 10, wherein the oleophilic or fluorophilic surface is a covalently bonded monolayer.

12. The liquid paint of claim 10, wherein one or more of the oleophilic surface and the fluorophilic surface is configured to one or more of:
provide the charge storage material with the first surface energy differential with respect to the liquid carrier;
provide the charge transporter with a second surface energy differential with respect to the liquid carrier that is less than the first surface energy differential; and
provide the charge photo-ejector material with a third surface energy differential with respect to the liquid carrier that is less than the first surface energy differential or the second surface energy differential.

13. The liquid paint of claim 1, further comprising a collection of bi-layer particles that each include a layer of the charge storage material in contact with a layer of the charge transporter material, wherein the charge transporter material is characterized by a second surface energy differential with respect to the carrier liquid such that the collection of bi-layer particles self-orients at least in part according to the first and second surface energy differentials to direct the layer of the charge storage material on the collection of bi-layer particles towards the air-liquid interface and to direct the layer of the charge transporter material on the collection of bi-layer particles away from the air-liquid interface.

14.-15. (canceled)

16. A method to form a photo-wettable painted coating on a surface, the method comprising:
painting a surface with a liquid paint that includes a carrier liquid, charge photo-ejector material, a charge transporter material, and a charge storage material, wherein the charge storage material is characterized by a first surface energy differential with respect to the carrier liquid;
allowing the charge storage material to self-segregate according to the first surface energy differential at a first average depth from an air-liquid interface of the liquid paint to leave at least a portion of the charge storage material located at the air-liquid interface; and
forming a painted coating by removing at least a portion of the carrier liquid from the liquid paint at the surface, such that the painted coating has an air-coating interface that includes the at least a portion of the self-segregated charge storage material,
wherein in the painted coating, the charge photo-ejector material is configured to absorb light and photo-eject a charge into the charge transporter material, the charge transporter material is configured to transport the charge from the charge photo-ejector material to the charge storage material, and the charge storage material is configured to store at least a portion of the charge at the air-coating interface to provide the photo-wettable painted coating.

17. The method of claim 16, further comprising allowing the charge transporter material to self-segregate at a second average depth from the air-liquid interface of the liquid paint that is greater than the first average depth, wherein:
the charge transporter material is characterized by a second surface energy differential with respect to the carrier liquid that is less than the first surface energy differential; and
the charge transporter material self-segregates at the second average depth according to the second surface energy differential.

18. The method of claim 17, further comprising allowing the charge transporter material to self-segregate at a third average depth from the air-liquid interface of the liquid paint that is greater than the first average depth, wherein:
the charge photo-ejector material is characterized by a third surface energy differential with respect to the carrier liquid that is less than the first surface energy differential; and
the charge transporter material self-segregates at the third average depth according to the third surface energy differential.

19.-21. (canceled)

22. The method of claim 16, further comprising:
providing the liquid paint with the charge storage material and the charge transporter material configured together as a collection of bi-layer particles that each include a layer of the charge storage material in contact with a layer of the charge transporter material; and
allowing the collection of bi-layer particles to self-orient such that the layer of the charge storage material on the collection of bi-layer particles self-orients towards the air-liquid interface and the layer of the charge transporter material on the collection of bi-layer particles self-orients away from the air-liquid interface, wherein
the charge transporter material is characterized by a second surface energy differential with respect to the carrier liquid; and
the collection of bi-layer particles self-orients at least in part according to the first and second surface energy differentials.

23. The method of claim 16, further comprising:
providing the liquid paint with the charge storage material and the charge photo-ejector material configured together as a collection of bi-layer particles that each include a layer of the charge transporter material in contact with a layer of the charge photo-ejector material;
allowing the collection of bi-layer particles to self-orient such that the layer of the charge transporter material on the collection of bi-layer particles self-orients towards the air-liquid interface and the layer of the charge photo-ejector material on the collection of bi-layer particles self-orients away from the air-liquid interface; and
allowing the collection of bi-layer particles to self-segregate at a second average depth from the air-liquid interface of the liquid paint that is greater than the first average depth, wherein
the charge transporter material is characterized by a second surface energy differential with respect to the carrier liquid;
the charge photo-ejector material is characterized by a third surface energy differential with respect to the carrier liquid; and
the collection of bi-layer particles self-orients at least in part according to the second and third surface energy differentials.

24. The method of claim 16, further comprising:
providing the liquid paint with the charge transporter material, the charge storage material, and the charge photo-ejector material configured together as a collection of tri-layer particles that each include a layer of the charge transporter material sandwiched between a layer of the charge storage material and a layer of the charge photo-ejector material; and
allowing the collection of tri-layer particles to self-orient according to the first surface energy differential and a third surface energy differential such that the layer of the charge storage material on the collection of tri-layer particles self-orients towards the air-liquid interface and the layer of the charge photo-ejector material on the collection of tri-layer particles self-orients away from the air-liquid interface, wherein
the charge transporter material is characterized by a second surface energy differential with respect to the carrier liquid;
the charge photo-ejector material is characterized by the third surface energy differential with respect to the carrier liquid that is less than the first surface energy differential; and
the collection of tri-layer particles self-orients at least in part according to the first surface energy differential and the third surface energy differential.

25.-42. (canceled)

43. A painted article, comprising:
an article that includes a surface;
a photo-wettable paint coating at the surface, the photo-wettable paint coating including:
a charge photo-ejector material;
a charge transporter material; and
a charge storage material; wherein
the charge storage material is located at a first average depth from an air-paint interface of the photo-wettable paint coating such that at least a portion of the charge storage material is located at the air-paint interface;
the charge photo-ejector material is configured to absorb light and photo-eject a charge into the charge transporter material, the charge transporter material is configured to transport the charge from the charge photo-ejector material to the charge storage material, and the charge storage material is configured to store at least a portion of the charge at the air-paint interface to provide the photo-wettable painted coating.

44.-45. (canceled)

46. The painted article of claim 43, wherein the charge storage material includes one or more of: silica; alumina; a fluoropolymer; a fluoroalkyl compound or group; a polyaliphatic, a polyester; or a combination, a compound, a composite, or a copolymer thereof.

47. (canceled)

48. The painted article of claim 43, wherein one or more of the charge photo-ejector material, the charge transporter material, and the charge storage material is configured as a collection of particles having an average diameter of about 1 nanometer to about 100 micrometers.

49. The painted article of claim 48, wherein the charge transporter material is located at a second average depth from an air-coating interface that is greater than the first average depth.

50. The painted article of claim 49, wherein the charge photo-ejector material is located at a third average depth from the air-coating interface that is greater than the first average depth.

51.-56. (canceled)
